(19) United States
(12) Patent Application Publication
(10) Pub. No.: US 2010/0095361 A1
(43) Pub. Date: Apr. 15, 2010

(54) Signaling security for IP multimedia services

(76) Inventor: Wenhua Wang, Lisle, IL (US)

Correspondence Address: Carmen Patti Law Group, LLC, One N. LaSalle Street, 44th Floor, Chicago, IL, 60602, US

(21) Appl. No.: 12/287,511

(22) Filed: Oct. 10, 2008

(51) Int. Cl. H04L 9/32; G06F 15/16; G06F 17/00

(52) U.S. Cl. 726/7; 709/228; 726/11

(57) ABSTRACT

An apparatus in one example has: a predetermined tunnel that operatively couples a UE and a firewall; and the predetermined tunnel structured to convey at least signaling messages. The embodiments according to the present method and apparatus provide a solution for signaling security of IP multimedia services that is compatible with firewalls. For example, such embodiments establish an IPsec or SSL/TLS tunnel between the UE and the firewall, instead of an end-to-end IPsec or SSL/TLS connection between the UE and the CSCF.

### TECHNICAL FIELD

The invention relates generally to telecommunication systems, and in particular to signaling security of IP multimedia services.

### BACKGROUND

The IP Multimedia Subsystem (IMS) is an architectural framework for delivering internet protocol (IP) multimedia to mobile users. It was originally designed by the wireless standards body 3rd Generation Partnership Project (3GPP), and is part of the vision for evolving mobile networks beyond GSM. Its original formulation (3GPP R5) represented an approach to delivering “Internet services” over GPRS. This vision was later updated by 3GPP, 3GPP2 and TISPAN by requiring support of networks other than GPRS, such as Wireless LAN, CDMA2000 and fixed line. To ease the integration with the Internet, IMS as far as possible uses IETF (i.e. Internet) protocols such as Session Initiation Protocol (SIP). The Home Subscriber Server (HSS) is a master user database that supports the IMS network entities that actually handle calls. It contains the subscription-related information (user profiles), performs authentication and authorization of the user, and can provide information about the user's physical location.

Several roles of Session Initiation Protocol (SIP) servers or proxies, collectively called Call Session Control Function (CSCF), are used to process SIP signalling packets in the IMS. Application servers (AS) host and execute services, and interface with a S-CSCF using Session Initiation Protocol (SIP).

Firewalls are usually placed at the connection to the Internet. They shield local networks from outside attacks by screening incoming traffic and rejecting connection attempts to host inside the firewalls by outside machines. Most firewall systems allow hosts inside the firewall to connect to hosts outside it (outgoing traffic). However, incoming traffic is most often disabled entirely. Unfortunately, the firewalls create significant problems for the operation of existing security measures.

### SUMMARY

One embodiment according to the present method and apparatus is an apparatus that may comprise: a predetermined tunnel that operatively couples a UE and a firewall; and the predetermined tunnel structured to convey at least signaling messages.

Another embodiment according to the present method and apparatus is a method that may comprise the steps of: establishing a predetermined tunnel between a UE and a firewall; sending signaling messages from the UE to the firewall; and decrypting, in the firewall, the signaling messages.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts a typical architecture diagram of an IP multimedia network offering services to its subscribers.

FIG. 2 depicts existing solutions for confidentiality and integrity of SIP messages.

FIG. 3 depicts a scenario wherein a firewall 313 is located between the UE 309 and the CSCF 307.

FIG. 4 depicts an embodiment according to the present method and apparatus.

FIG. 5 shows a message flow diagram of a method according to the present method and apparatus of SSL/TLS tunnel establishment between the UE and the firewall as part of a successful UE registration.

FIG. 6 depicts a more general embodiment of the present method.

### DETAILED DESCRIPTION

The embodiments according to the present method and apparatus provide a solution for signaling security of IP multimedia services that is compatible with firewalls. Such embodiments establish an IPsec or SSL/TLS tunnel between the UE and the firewall, instead of an end-to-end IPsec or SSL/TLS connection between the UE and the CSCF.

In general, a telecommunication system may be a circuit switched communication system, a VoIP communication system, a video communication system, or any other type of communication system. Furthermore, a terminal may refer to a landline phone, a cellular phone, a VoIP phone, a personal data assistant, a personal computer, etc.

Tunnels are host protocols, which encapsulate other protocols by multiplexing them at one end and demultiplexing them at the other end. Any protocol can be tunneled by a tunnel protocol.

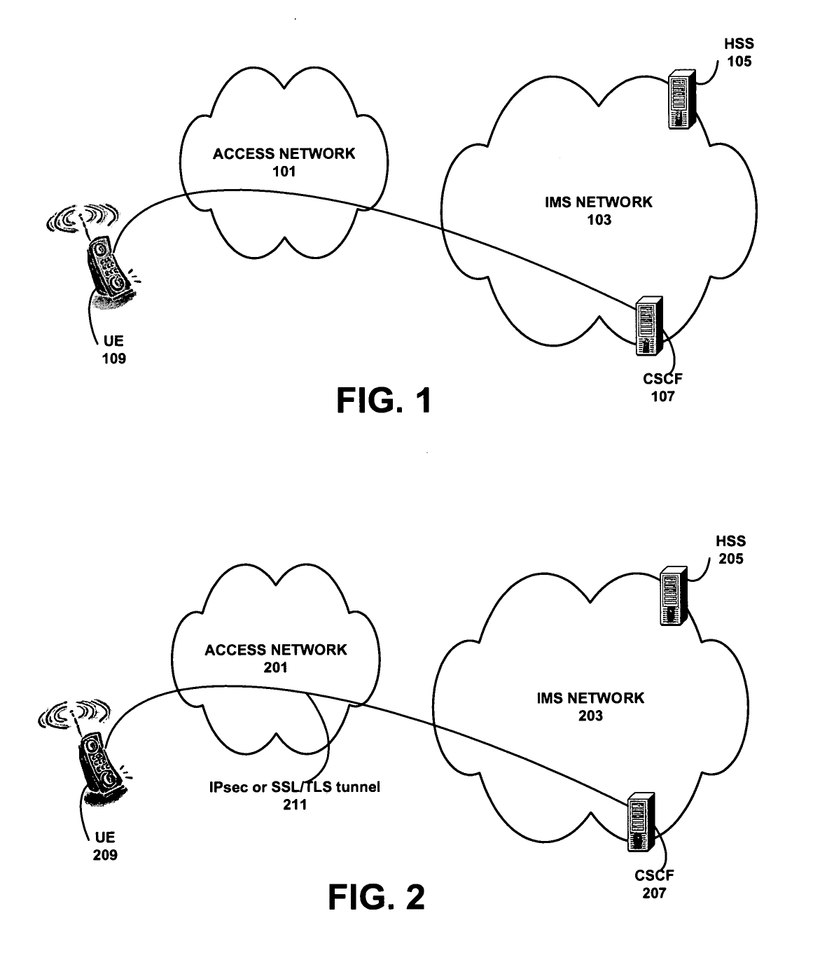

FIG. 1 depicts a typical architecture diagram of an IP multimedia network offering services to its subscribers. The diagram only shows signaling path between a UE 109 (User Equipment) and a CSCF 107 (Call Session Control Function). The CSCF 107 may be in an IMS network 103 that also contains an HSS 105. The signaling protocol between the UE 109 and the CSCF 107 may be SIP (Session Initiation Protocol). The SIP signaling messages between the UE 109 and the CSCF 107 pass through an access network 101, which may not be secure. A security mechanism must be in place to protect the confidentiality and integrity of SIP signaling messages between the UE 109 and the CSCF 107.

IPsec (IP security) is a suite of protocols for securing Internet Protocol (IP) communications by authenticating and/or encrypting each IP packet in a data stream. IPsec also includes protocols for cryptographic key establishment. The IP security architecture uses the concept of a security association as the basis for building security functions into IP. A security association is simply the bundle of algorithms and parameters (such as keys) that is being used to encrypt and authenticate a particular flow in one direction. Therefore, in normal bidirectional traffic, the flows are secured by a pair of security associations. The actual choice of encryption and authentication algorithms (from a defined list) is left to the IPsec administrator.

FIG. 2 depicts existing solutions for confidentiality and integrity of SIP messages. The existing solutions establish an IPsec (IP Security) or SSL/TLS (Secure Socket Layer/Transport Layer Security) tunnel 211 via the access network 201 between the UE 209 and the CSCF 207 in the IMS network 203 that also contains an HSS 205. The IPsec or SSL/TLS connection is established as part of a successful UE registration. The subsequent SIP signaling messages are carried over the IPsec or SSL/TLS, which provides confidentiality and integrity of SIP messages.

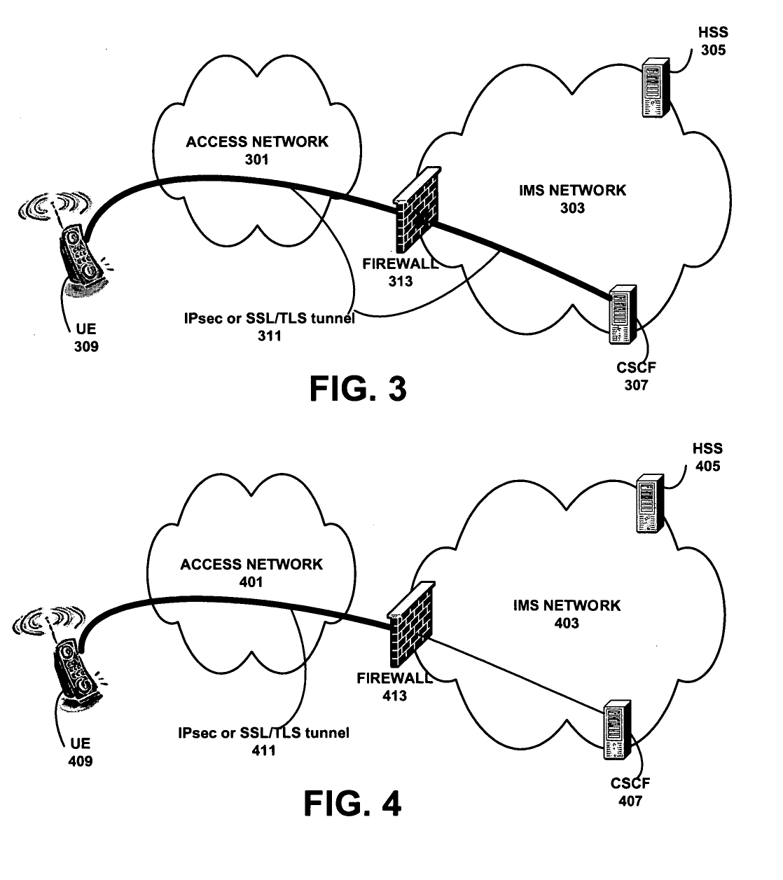

FIG. 3 depicts a scenario wherein a firewall 313 is located between the UE 309 and the CSCF 307. A significant drawback is that existing security measures are not firewall compatible. It's very common for a service provider to deploy firewalls on the edge of an IP multimedia network (IMS network 303) to protect the network from security attacks. FIG. 3 depicts a scenario in which a firewall 313 sits between the UE 309 and the CSCF 307, and the SIP signaling messages between the UE 309 and the CSCF 307 pass through the firewall 313 after traversing the access network 301. If SIP signaling messages between the UE 309 and the CSCF 307 are carried over IPsec or SSL/TLS tunnel 311, the ability of firewall 313 to inspect and filter messages is severely limited due to the encryption of messages. For example, it's impossible for the firewall 313 to inspect messages at SIP layer and filter bad-formed SIP messages.

TLS (Transport Layer Security) is a security protocol from the IETF that is based on the Secure Sockets Layer (SSL) 3.0 protocol. TLS uses digital certificates to authenticate the user as well as authenticate the network. The TLS client uses the public key from the server to encrypt a random number and send it back to the server. The random number, combined with additional random numbers previously sent to each other, is used to generate a secret session key to encrypt the subsequent message exchange.

FIG. 4 depicts an embodiment according to the present method and apparatus. This embodiment establishes an IPsec or SSL/TLS tunnel 411 between the UE 409 and the firewall 413, instead of an end-to-end IPsec or SSL/TLS connection between the UE 409 and the CSCF 407. The IPsec or SSL/TLS tunnel 411 may be established before or as part of the UE's registration to the IMS network 403. Since SIP signaling messages from the UE 409 to the firewall 413 are decrypted in the firewall 413, they can be inspected and filtered by the firewall 413. Compared with the existing solutions, embodiments according to the present method and apparatus provide the same level of security protection for signaling messages that pass through the access network 401. Although the embodiments according to the present method and apparatus do not provide protection between the firewall 413 and the CSCF 407, the firewall 413, the CSCF 407, the HSS 405, and the IMS network 403 belong within the service provider's domain. The need for security protection for the messages that pass through this domain is different from and is not as strong as that for the access network 401.

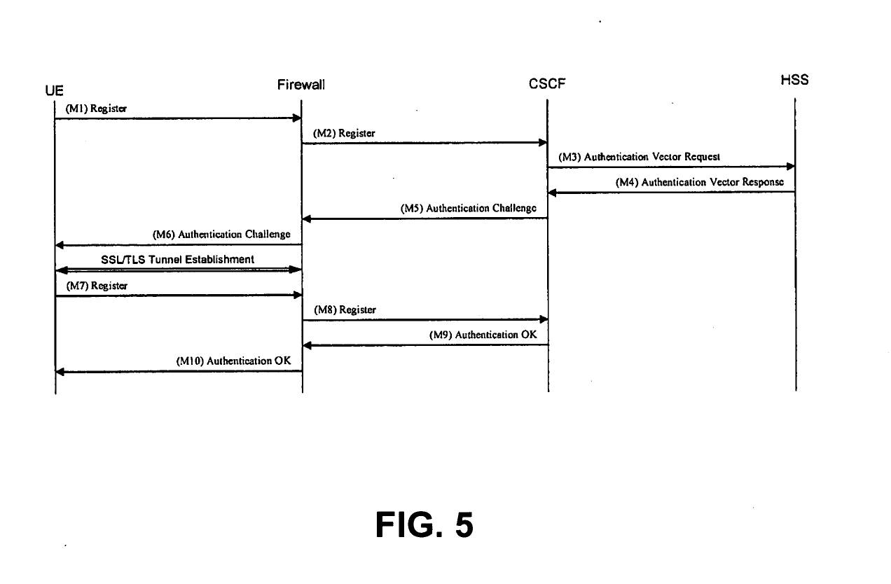

FIG. 5 shows a message flow diagram of a method according to the present method and apparatus of SSL/TLS tunnel establishment between the UE and the firewall as part of a successful UE registration. The UE authentication to IMS uses SIP Digest. In this embodiment the method may comprise:

M1: The UE initiates a SIP registration;

M2: The firewall inspects message M1. If it passes the inspection, the firewall forwards the message (M2) to the CSCF;

M3: After receiving M2, the CSCF requests an authentication vector from the HSS (Home Subscriber Server);

M4: The HSS sends the authentication vector to the CSCF;

M5: The CSCF sends an authentication challenge message to the UE;

M6: The firewall forwards the authentication challenge to the UE;

SSL/TLS tunnel establishment: Upon receiving the authentication challenge, the UE initiates a SSL/TLS handshake with the firewall. The firewall authenticates to the UE using a digital certificate. All signaling messages after this point between the UE and the firewall pass through this tunnel;

M7: The UE sends a SIP registration message with authentication parameters;

M8: The firewall gets M7, decrypts and inspects it. If it passes the inspection, the firewall forwards the decrypted M8 to the CSCF;

M9: The CSCF checks the authentication parameters and authenticates the UE. It then sends an authentication OK message to the UE; and

M10: The firewall forwards the authentication OK message to the UE. The UE registration is complete when the UE receives the authentication OK message.

In an alternative embodiment according to the present method and apparatus an IPsec tunnel is established between the UE and the firewall as part of successful UE registration. The message flow in this case is very similar to that in the case of SSL/TLS tunnel establishment depicted in FIG. 5. However, instead of establishing a SSL/TLS tunnel, an IPsec tunnel is established between the UE and the firewall.

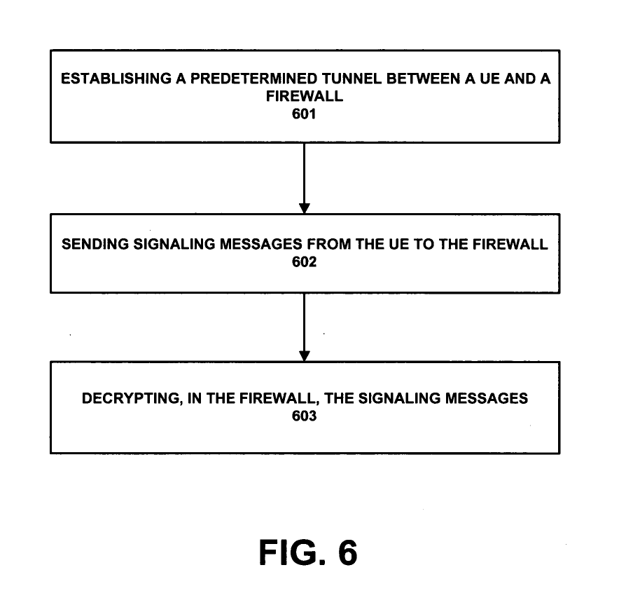

FIG. 6 depicts a more general embodiment of the present method. This embodiment may have the steps of: establishing a predetermined tunnel between a UE and a firewall (step 601); sending signaling messages from the UE to the firewall (step 602); and decrypting, in the firewall, the signaling messages (step 603).

Thus, in general, the security part is moved from the CSCF to the firewall. Therefore, the firewall has a new function that is implemented by the security part in the firewall. The tunnel is provided for encrypting and integrity, and the tunnel is used with the firewall for security.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium for the apparatus in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following.

What is claimed is:

1. An apparatus, comprising:
a predetermined tunnel that operatively couples a UE and a firewall; and
the predetermined tunnel structured to convey at least signaling messages.

2. The apparatus according to claim 1, wherein the signaling messages are SIP signaling messages.

3. The apparatus according to claim 1, wherein the predetermined tunnel is one of a IPsec tunnel and a SSL/TLS tunnel.

4. The apparatus according to claim 1, wherein the method further comprises forwarding the signaling messages from the firewall to a CSCF, and wherein the predetermined tunnel between the UE and the firewall replaces an end-to-end connection between the UE and the CSCF.

5. The apparatus according to claim 1, wherein the firewall is operatively coupled to an IMS network, and wherein the predetermined tunnel is established before a registration of the UE to the IMS network.

6. The apparatus according to claim 1, wherein the firewall is operatively coupled to an IMS network, and wherein the predetermined tunnel is established as part of a registration of the UE to the IMS network.

7. A method, comprising:
establishing a predetermined tunnel between a UE and a firewall;
sending signaling messages from the UE to the firewall; and
decrypting, in the firewall, the signaling messages.

8. The method according to claim 7, wherein the signaling messages are SIP signaling messages.

9. The method according to claim 7, wherein the method further comprises inspecting and filtering the signaling messages in the firewall.

10. The method according to claim 7, wherein the method further comprises forwarding the signaling messages from the firewall to a CSCF.

11. The method according to claim 10, wherein the predetermined tunnel between the UE and the firewall replaces an end-to-end connection between the UE and the CSCF.

12. The method according to claim 7, wherein the predetermined tunnel is one of a IPsec tunnel and a SSL/TLS tunnel.

13. The method according to claim 7, wherein the firewall is operatively coupled to an IMS network, and wherein the predetermined tunnel is established before a registration of the UE to the IMS network.

14. The method according to claim 7, wherein the firewall is operatively coupled to an IMS network, and wherein the predetermined tunnel is established as part of a registration of the UE to the IMS network.

15. A method, comprising:
M1: a UE initiates a SIP registration;
M2: a firewall inspects message M1, and if the registration passes the inspection, the firewall forwarding a message M2 to a CSCF;
M3: after receiving message M2, the CSCF requesting an authentication vector from a HSS (Home Subscriber Server);
M4: the HSS sending the authentication vector to the CSCF;
M5: the CSCF sending an authentication challenge message to the firewall for the UE;
M6: The firewall forwarding the authentication challenge to the UE; and
SSL/TLS tunnel establishment: Upon receiving the authentication challenge, establishing a tunnel between the UE and the firewall.

16. The method according to claim 15, wherein the method further comprises: the UE initiating a SSL/TLS handshake with the firewall, the firewall authenticating to the UE using a digital certificate, and all signaling messages after this point between the UE and the firewall passing through the tunnel.

17. The method according to claim 16, wherein the method further comprises:
M7: the UE sending a SIP registration message with authentication parameters;
M8: The firewall receiving, decrypting and inspecting message M7, and if the message M7 passes the inspection, the firewall forwarding a decrypted message M8 to the CSCF;
M9: The CSCF checking the authentication parameters and authenticating the UE and then sending an authentication OK message to firewall for the UE; and
M10: The firewall forwards the authentication OK message to the UE, the UE registration being complete when the UE receives the authentication OK message.

18. The method according to claim 15, wherein the tunnel between the UE and the firewall replaces an end-to-end connection between the UE and the CSCF.

19. The method according to claim 15, wherein the tunnel is a IPsec tunnel.

20. The method according to claim 15, wherein the tunnel is a SSL/TLS tunnel.
